(19) United States
(12) Patent Application Publication
(10) Pub. No.: US 2025/0219273 A1
(43) Pub. Date: Jul. 3, 2025

(54) ELECTROLYTE INJECTION APPARATUS

(71) Applicant: SAMSUNG SDI CO., LTD., Yongin-si (KR)

(72) Inventors: Hyunsuk PARK, Yongin-si (KR); Seungman LIM, Yongin-si (KR); Myunghwan SEO, Yongin-si (KR)

(21) Appl. No.: 18/883,833

(22) Filed: Sep. 12, 2024

(30) Foreign Application Priority Data
Dec. 28, 2023 (KR) 10-2023-0195669

(51) Int. Cl. H01M 50/609; H01M 10/04

(52) U.S. Cl. CPC H01M 50/609; H01M 10/0404

(57) ABSTRACT

An electrolyte injection apparatus includes: a carrier; a plurality of battery containers aligned and mounted on the carrier; a vacuum chamber in which the carrier is movably accommodated; and an injection nozzle fixed while penetrating an upper surface of the vacuum chamber and configured to discharge an electrolyte and to supply the electrolyte to the battery containers.

### CROSS-REFERENCE TO RELATED APPLICATION

The present application claims priority to and the benefit of Korean Patent Application No. 10-2023-0195669, filed on Dec. 28, 2023, in the Korean Intellectual Property Office, the entire disclosure of which is incorporated herein by reference.

### BACKGROUND

### 1. Field

Aspects of some embodiments of the present disclosure relate to an electrolyte injection apparatus.

### 2. Description of Related Art

A rechargeable battery may include an electrode assembly having a positive electrode, a negative electrode, and a separator interposed between the positive electrode and the negative electrode, and a bare cell having an electrolyte with which the electrode assembly is impregnated. In general, in order to manufacture the rechargeable battery, an electrolyte injection process of inserting the electrode assembly into a can or the like and then injecting an electrolyte may be performed, and a process of finishing a rechargeable battery assembled product by sealing the can.

As the process of injecting an electrolyte into the rechargeable battery, a carrier/chamber type electrolyte injection method may be used to increase the amount of production of the rechargeable batteries. During the process of injecting the electrolyte by using the carrier/chamber type electrolyte injection method, the electrolyte flows downward and contaminates a vacuum chamber and a carrier upper plate, which may cause electrolyte salt. The electrolyte salt may act as an obstacle when the carrier and the vacuum chamber are tightly attached to each other, which may cause a problem in that the electrolyte leaks without being introduced into the bare cell when the vacuum for injecting the electrolyte is released.

For this reason, management costs for periodically cleaning the carrier and the vacuum chamber to remove the contamination caused by the electrolyte salt are incurred, and manufacturing efficiency in manufacturing the bare cell may be degraded by an insufficient amount of injection of the electrolyte, an increase in the amount of consumption of the electrolyte, and the like.

The above information disclosed in this Background section is only for enhancement of understanding of the background and therefore the information discussed in this Background section does not necessarily constitute prior art.

### SUMMARY

Aspects of some embodiments of the present disclosure include an electrolyte injection apparatus capable of minimizing or reducing contamination caused by an electrolyte that may occur at the time of injecting the electrolyte during a process of injecting the electrolyte into a rechargeable battery, thereby injecting the electrolyte while maintaining a relatively low degree of vacuum in a vacuum chamber.

However, the characteristics of embodiments of the present disclosure are not limited to the above-mentioned characteristics but may be variously expanded without departing from the spirit and scope of embodiments according to the present disclosure.

According to some embodiments of the present disclosure, an electrolyte injection apparatus includes: a carrier configured such that a plurality of battery containers is aligned and mounted on carrier; a vacuum chamber in which the carrier is movably accommodated; and an injection nozzle fixed while penetrating an upper surface of the vacuum chamber and configured to discharge an electrolyte and supply the electrolyte to the battery containers.

According to some embodiments, the injection nozzle may protrude from the upper surface of the vacuum chamber toward the inside of the vacuum chamber.

According to some embodiments, a part of the injection nozzle may be positioned in the vacuum chamber, and another part of the injection nozzle may be outside the vacuum chamber.

According to some embodiments, the injection nozzle may include a plurality of injection nozzles, and the number of injection nozzles may be smaller than the number of battery containers.

According to some embodiments, the plurality of injection nozzles may be arranged in a first direction parallel to an entering direction of the carrier, and the plurality of battery containers may be arranged in the first direction.

According to some embodiments, the plurality of injection nozzles may include injection nozzles of m×n in a first direction parallel to an entering direction of the carrier and a second direction perpendicular to the first direction, the plurality of battery containers may include battery containers of p×q in the first direction and the second direction, m, n, p, and q may be positive integers, m may be smaller than p, and n may be equal to q. p may be a multiple of m.

According to some embodiments, the carrier may include a lower carrier part on which the plurality of battery containers is mounted, and an upper carrier part positioned above the battery container, and the upper carrier part may include an injection hopper configured to penetrate the upper carrier part in an upward/downward direction and communicate with the inside of the battery container and configured to correspond to the injection nozzle.

According to some embodiments, a distance from a discharge port of the injection nozzle to a bottom surface of the vacuum chamber may be larger than a height from a bottom surface of the carrier to an upper end of the injection hopper.

According to some embodiments, the electrolyte injection apparatus may further include a time control valve connected to the injection nozzle and configured to adjust a capacity of the electrolyte to be injected by controlling an opening/closing operation on a time basis.

According to some embodiments, the electrolyte injection apparatus may further include a carrier drive part configured to provide driving power to move the carrier in the vacuum chamber.

According to some embodiments of the present disclosure, in an electrolyte injection apparatus, the contamination on the upper portion of the carrier, which accommodates the battery container, and the electrolyte injection port of the vacuum chamber, may be eliminated or reduced, which may minimize or reduce the contamination caused by the electrolyte during the process of injecting the electrolyte.

According to some embodiments, the time control valve may be connected to the electrolyte injection nozzle and control the amount of injection of the electrolyte, such that the electrolyte may be injected in the state in which the degree of vacuum in the vacuum chamber is constantly maintained to be low, thereby reducing costs for the vacuum pump and the related consumable components for maintaining a high-vacuum state.

### BRIEF DESCRIPTION OF THE DRAWINGS

FIG. 1 is a side view illustrating an electrolyte injection apparatus according to some embodiments.

FIG. 2 is an enlarged view of an injection nozzle of the electrolyte injection apparatus illustrated in FIG. 1.

FIG. 3 is a perspective view illustrating a state made before an electrolyte is injected during an electrolyte injection process by using the electrolyte injection apparatus according to some embodiments.

FIG. 4 is a side view of FIG. 3.

FIG. 5 is a perspective view illustrating an injection state during the electrolyte injection process by using the electrolyte injection apparatus according to some embodiments.

FIG. 6 is a side view of FIG. 5.

FIG. 7 is a perspective view illustrating an injection completion state during the electrolyte injection process by using the electrolyte injection apparatus according to some embodiments.

FIG. 8 is a side view of FIG. 7.

### DETAILED DESCRIPTION

Hereinafter, aspects of some embodiments of the present disclosure will be described in more detail with reference to the accompanying drawings so that those with ordinary skill in the art to which the present disclosure pertains may easily carry out the embodiments. In the drawings, a part irrelevant to the description will be omitted to clearly describe the present disclosure, and the same or similar constituent elements will be designated by the same reference numerals throughout the specification. In addition, some constituent elements in the accompanying drawings are illustrated in an exaggerated or schematic form or are omitted. A size of each constituent element does not entirely reflect an actual size.

It should be interpreted that the accompanying drawings are provided only to allow those skilled in the art to understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

In addition, when one component such as a layer, a film, an area, or a plate is described as being positioned “above” or “on” another component, one component can be positioned “directly on” another component, and one component can also be positioned on another component with other components interposed therebetween. On the contrary, when one component is described as being positioned “directly above” another component, there is no component therebetween. In addition, when a component is described as being positioned “above” or “on” a reference part, the component may be positioned “above” or “below” the reference part, and this configuration does not necessarily mean that the component is positioned “above” or “on” the reference part in a direction opposite to gravity.

Throughout the specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof. Therefore, unless explicitly described to the contrary, the word “comprise/include” and variations such as “comprises/includes” or “comprising/including” will be understood to imply the inclusion of stated elements, not the exclusion of any other elements.

In addition, throughout the specification, the phrase “in a plan view” means when an object is viewed from above, and the phrase “in a cross-sectional view” means when a cross section made by vertically cutting an object is viewed from a lateral side.

In addition, throughout the specification, when one constituent element is referred to as being “connected to” another constituent element, one constituent element can be “directly connected to” the other constituent element, and one constituent element can also be “indirectly connected to,” “physically connected to,” or “electrically connected to” the other element with other elements therebetween. Further, the constituent elements are defined as different names according to positions or functions thereof, but the constituent elements may be integrated.

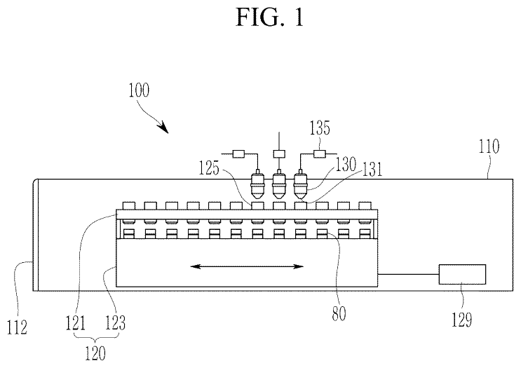

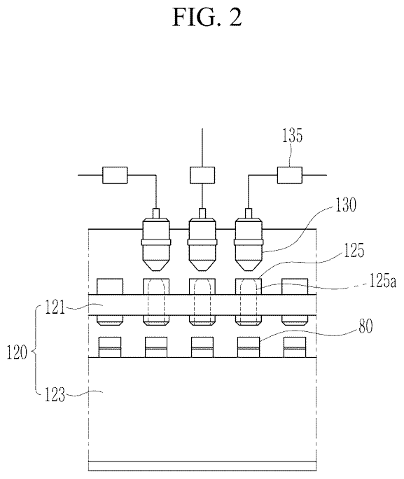

FIG. 1 is a side view illustrating an electrolyte injection apparatus according to some embodiments, and FIG. 2 is an enlarged view of an injection nozzle of the electrolyte injection apparatus illustrated in FIG. 1.

With reference to FIG. 1, an electrolyte injection apparatus 100 according to some embodiments may include a carrier 120 accommodated in a vacuum chamber 110, and a plurality of battery containers 80 may be mounted on the carrier 120. Injection nozzles 130 for discharging an electrolyte may be fixed to an upper surface of the vacuum chamber 110. The injection nozzle 130 may be fixed while penetrating the upper surface of the vacuum chamber 110, and the electrolyte discharged through the injection nozzle 130 may be supplied into the battery container 80.

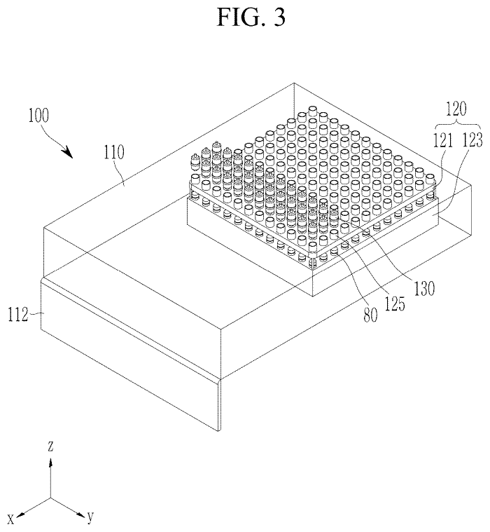

The carrier 120 may include an upper carrier part 121 and a lower carrier part 123, injection hoppers 125 may be located on the upper carrier part 121, and the battery containers 80 may be mounted on the lower carrier part 123. The injection hoppers 125 may be provided as a plurality of injection hoppers 125 and located on upper portions of the battery containers 80. The plurality of injection hoppers 125 may penetrate the upper carrier part 121 in an upward/downward direction and be configured to correspond to the plurality of battery containers 80. The battery container 80 may be opened upward and communicate with the interior of the injection hopper 125. The plurality of battery containers 80 and the plurality of injection hoppers 125 may be located on the carrier 120 in a two-dimensional manner upward, downward, leftward, and rightward in a planar direction (see FIG. 3).

The injection nozzle 130 may protrude from the upper surface of the vacuum chamber 110 toward the inside of the vacuum chamber 110. A part of the injection nozzle 130, which is fixed while penetrating the upper surface of the vacuum chamber 110, may be positioned in the vacuum chamber 110, and another part of the injection nozzle 130 may be positioned outside the vacuum chamber 110. That is, the injection nozzle 130 may extend into the vacuum chamber 110, but may not be entirely enclosed by the vacuum chamber 110, and a portion (e.g., a top portion) of the nozzle 130 may extend outside of the vacuum chamber 110. A part of the injection nozzle 130, which is positioned inside the vacuum chamber 110, may include a discharge port 131 through which the electrolyte is discharged.

The vacuum chamber 110 may have an approximately rectangular parallelepiped shape, and an openable and closable door 112 may be installed at one side of the vacuum chamber 110. The carrier 120, on which the battery containers 80 are mounted, may enter the vacuum chamber 110 through the door 112. A height of the vacuum chamber 110 may be set so that the injection hopper 125 located on the upper carrier 120 does not interfere with the injection nozzle 130, which protrudes toward the inside of the vacuum chamber 110, when the carrier 120 moves in the vacuum chamber 110. Therefore, a distance from the discharge port 131 of the injection nozzle 130 to a bottom surface of the vacuum chamber 110 may be larger than a height from a bottom surface of the carrier 120 to an upper end of the injection hopper 125.

With reference to FIG. 2, the injection hopper 125 may include a buffer part 125a that is a space that stores the electrolyte therein. The injection hopper 125 may include an upper injection port opened toward an upper side of the buffer part 125a, and a lower injection port opened toward a lower side of the buffer part 125a. The upper injection port of the buffer part 125a may correspond to the discharge port 131 of the injection nozzle 130, and the lower injection port of the buffer part 125a may correspond to an upper end opening portion of the battery container 80.

The battery container 80 may be configured as a can of a cylindrical rechargeable battery. A jelly roll electrode assembly, which includes a positive electrode, a negative electrode, and a separator interposed between the positive electrode and the negative electrode, may be accommodated in the battery container 80. In the present embodiments, the cylindrical rechargeable battery is described as an example. However, embodiments according to the present disclosure are not limited thereto. The battery container may be a can of an angular rechargeable battery.

The injection nozzle 130 may be connected to a reservoir, which stores the electrolyte, and receive the electrolyte. The injection nozzle 130 may be connected to a pump or valve, which discharges the electrolyte, and perform a function of discharging the electrolyte.

In case that the valve is connected to the injection nozzle 130, a time control valve 135 may be connected to the injection nozzle 130, and the time control valve 135 may adjust a capacity of the electrolyte to be injected while controlling the opening and closing operations on a time basis. The time control valve 135 may control on/off on a microsecond time basis, and allows for a simpler, more intuitive, and lower cost facility configuration in comparison with a case in which a pump is connected. In order to improve the dispersion related to the electrolyte discharge amount in case that the time control valve 135 is used, a degree of vacuum in the vacuum chamber 110 needs to be decreased. However, as the degree of vacuum decreases, a level of impregnation of the jelly roll electrode assembly with the electrolyte decreases. Therefore, the time control valve 135 may be used under a condition of −93 kPa to −87 kPa.

In the electrolyte injection apparatus 100 according to some embodiments, the number of injection nozzles 130 may be smaller than the number of injection hoppers 125. The number of injection nozzles 130, which are arranged in a first direction (an x-axis direction in the drawings) parallel to an entering direction of the carrier 120, is smaller than the number of injection hoppers 125 arranged in the first direction. The injection nozzle 130 may be fixed to the vacuum chamber 110, and the carrier 120 may move in the vacuum chamber 110 in the state in which the battery container 80 is mounted. Therefore, the carrier 120 may sequentially move while injecting the electrolyte into the battery containers 80 by the number of injection nozzles 130 at once.

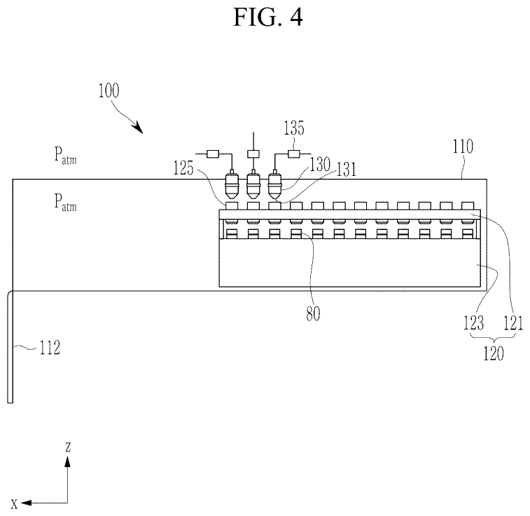

FIG. 3 is a perspective view illustrating a state made before an electrolyte is injected during an electrolyte injection process by using the electrolyte injection apparatus according to some embodiments, and FIG. 4 is a side view of FIG. 3.

With reference to FIGS. 3 and 4, the electrolyte injection apparatus 100 according to some embodiments may include the injection nozzles 130 arranged such that the number of injection nozzles 130 is m in the first direction (the x-axis direction in the drawings), and the number of injection nozzles 130 is n in a second direction (a y-axis direction in the drawings) perpendicular to the first direction (here, m and n are positive integers). Therefore, the electrolyte injection apparatus 100 may include the injection nozzles 130 of m×n. For example, as illustrated, the electrolyte injection apparatus 100 may include the injection nozzles 130 of three×twelve. The carrier 120 may include p battery containers 80 arranged in the first direction, and q battery containers 80 arranged in the second direction (here, p and q are positive integers). Therefore, the carrier 120 may include the battery containers 80 of p×q. For example, as illustrated, the carrier 120 may include the battery containers 80 of twelve×twelve. In addition, like the number of battery containers 80, the injection hoppers 125 of p×q may be located on the lower carrier part 123. For example, as illustrated, the injection hoppers of twelve×twelve may be included.

According to some embodiments, m, which is the number of injection nozzles 130 in the first direction, may be smaller than p that is the number of battery containers 80 in the first direction. In this case, p may be a multiple of m. In addition, n, which is the number of injection nozzles 130 in the second direction may be equal to q that is the number of battery containers 80 in the second direction. Therefore, the electrolyte discharged from the injection nozzles 130 may be injected into the battery containers 80 while the carrier 120 moves in the first direction in the vacuum chamber 110.

With reference to FIGS. 3 and 4, in order to inject the electrolyte into the battery containers 80 by using the electrolyte injection apparatus 100 according to some embodiments, the door 112 of the vacuum chamber 110 may be opened, and the carrier 120, on which the battery containers 80 are mounted, may enter the vacuum chamber 110 in the first direction (the x-axis direction in the drawings). In this case, pressure in the vacuum chamber 110 may be equal to atmospheric pressure (Pₐₜₘ) outside the vacuum chamber 110.

The carrier 120 may be moved in the vacuum chamber 110 and positioned so that a first column of the injection nozzles 130 and a first column of the battery containers 80 may be connected to each other. In this state, the door 112 may be closed, the internal pressure of the vacuum chamber 110 may be lowered, and then the injection nozzles 130 may operate to inject the electrolyte into the battery containers 80.

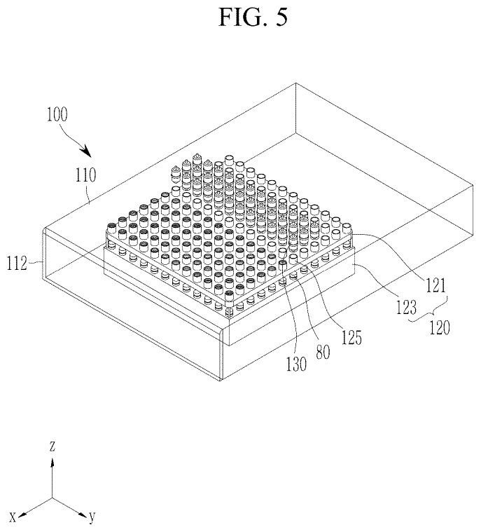

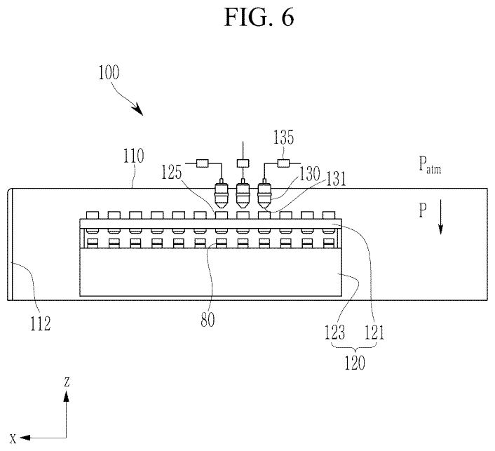

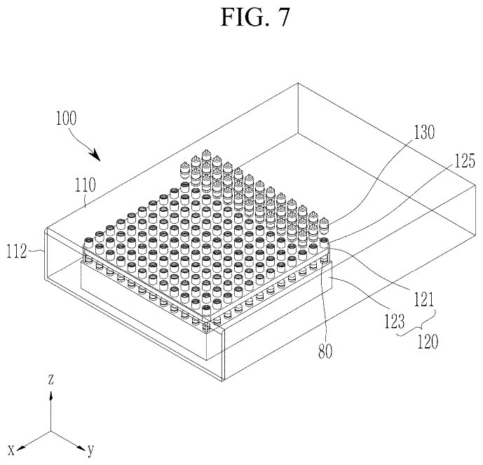

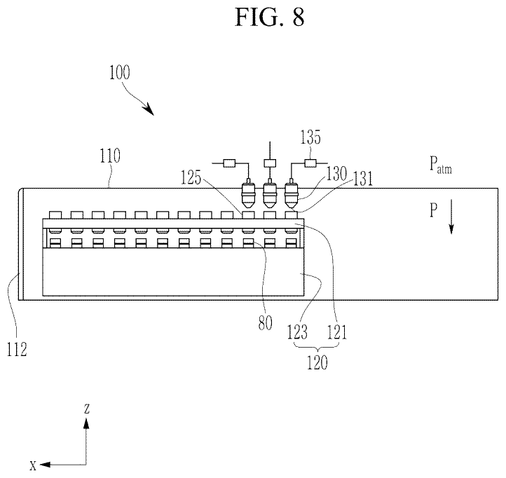

FIG. 5 is a perspective view illustrating an injection state during the electrolyte injection process by using the electrolyte injection apparatus according to some embodiments, and FIG. 6 is a side view of FIG. 5. FIG. 7 is a perspective view illustrating an injection completion state during the electrolyte injection process by using the electrolyte injection apparatus according to some embodiments, and FIG. 8 is a side view of FIG. 7.

With reference to FIGS. 5 and 6, when the door 112 is closed and the injection process is performed, the pressure in the vacuum chamber 110 may be maintained to be lower than outside atmospheric pressure (Pₐₜₘ). In this state, the electrolyte may be injected into the battery containers 80 by the number of injection nozzles 130 at once, and then the carrier 120 may be moved in the first direction (the x-axis direction in the drawings) to perform the next process. In this case, the carrier 120 may move so that the battery containers 80 are moved by m that is the number of injection nozzles 130 in the first direction (the number of columns).

With reference to FIGS. 7 and 8, p, which is the number of the battery containers 80 mounted on the carrier 120 and arranged in the first direction (the number of columns), may be a multiple of m that is the number of injection nozzles 130 in the first direction. Therefore, the injection process may be completed in a state in which no column of the injection nozzles 130 or the battery containers 80 remains during the final injection process.

While aspects of some embodiments of the present disclosure have been described above, embodiments according to the present disclosure are not limited thereto, and various modifications can be made and carried out within the scope of embodiments according to the present disclosure, and also fall within the scope of embodiments according to the present disclosure, for example, as defined by the appended claims, and their equivalents.

### DESCRIPTION OF SOME OF THE REFERENCE SYMBOLS

100: Electrolyte injection apparatus
110: Vacuum chamber
112: Door
120: Carrier
121: Upper carrier part
123: Lower carrier part
125: Injection hopper
130: Injection nozzle
135: Time control valve

1 what is claimed is:

1. An electrolyte injection apparatus comprising:
a carrier;
a plurality of battery containers aligned and mounted on the carrier;
a vacuum chamber in which the carrier is movably accommodated; and
an injection nozzle fixed while penetrating an upper surface of the vacuum chamber and configured to discharge an electrolyte and to supply the electrolyte to the battery containers.

2. The electrolyte injection apparatus as claimed in claim 1, wherein the injection nozzle protrudes from the upper surface of the vacuum chamber toward the inside of the vacuum chamber.

3. The electrolyte injection apparatus as claimed in claim 1, wherein a part of the injection nozzle is positioned in the vacuum chamber, and another part of the injection nozzle is outside the vacuum chamber.

4. The electrolyte injection apparatus as claimed in claim 1, wherein the injection nozzle comprises a plurality of injection nozzles, and a number of the injection nozzles is smaller than a number of the battery containers.

5. The electrolyte injection apparatus as claimed in claim 1, wherein the plurality of injection nozzles is arranged in a first direction parallel to an entering direction of the carrier, and
the plurality of battery containers is arranged in the first direction.

6. The electrolyte injection apparatus as claimed in claim 1, wherein
the plurality of injection nozzles comprises injection nozzles of m×n in a first direction parallel to an entering direction of the carrier and a second direction perpendicular to the first direction,
the plurality of battery containers comprises battery containers of p×q in the first direction and the second direction,
m, n, p, and q are positive integers,
m is smaller than p, and n is equal to q.

7. The electrolyte injection apparatus as claimed in claim 1, wherein
p is a multiple of m.

8. The electrolyte injection apparatus as claimed in claim 1, wherein
the carrier comprises a lower carrier part on which the plurality of battery containers is mounted, and an upper carrier part above the battery container, and
the upper carrier part comprises an injection hopper configured to penetrate the upper carrier part in an upward/downward direction and communicate with the inside of the battery container and configured to correspond to the injection nozzle.

9. The electrolyte injection apparatus as claimed in claim 1, wherein a distance from a discharge port of the injection nozzle to a bottom surface of the vacuum chamber is larger than a height from a bottom surface of the carrier to an upper end of the injection hopper.

10. The electrolyte injection apparatus as claimed in claim 1, further comprising:
1 a time control valve connected to the injection nozzle and configured to adjust a capacity of the electrolyte to be injected by controlling an opening/closing operation on a time basis.

11. The electrolyte injection apparatus as claimed in claim 1, further comprising:
a carrier drive part configured to provide driving power to move the carrier in the vacuum chamber.
